(19) United States
(12) Patent Application Publication
(10) Pub. No.: US 2021/0389732 A1
(43) Pub. Date: Dec. 16, 2021

(54) Digital Clock with Free Form Path

(71) Applicant: John L. Schooley, Carlsbad, CA (US)

(72) Inventor: John L. Schooley, Carlsbad, CA (US)

(21) Appl. No.: 17/304,061

(22) Filed: Jun. 14, 2021

Related U.S. Application Data
(60) Provisional application No. 62/705,183, filed on Jun. 15, 2020.

(51) Int. Cl. G04G 9/00; G04G 5/04

(52) U.S. Cl. CPC G04G 9/0041; G04G 5/04; G04G 9/0047

(57) ABSTRACT

A clock that runs along a path while lighting elements along the path. Each element along the path can be lit in a different color. One of the colors represents hours one represents minutes and the other represents seconds. Values which are lit continually change as times change, but this allows an artistic display of time.

This application claims priority from Provisional application No. 62/705,183, filed Jun. 15, 2020, the entire contents of which are herewith incorporated by reference.

### BACKGROUND

Typical clocks are confined to a few set formats of layout. A clock often has a radial exterior and specified markings. Typical forms include moving clock hands with marking points including circles and numbers.

Digital clocks often just display the time as a series of numbers.

Because of the formats that have conventionally been used to display the time, it is difficult to form a clock that is a true artistic piece.

### SUMMARY OF THE INVENTION

The inventor recognized that there are a number of drawbacks with the current systems.

The embodiments describe embodiments, that are clocks that use indicators, e.g., LED lights, displayed along a path to display the time by defining the time along the path. These clocks can display the time along any desired path, and hence can allow any number of artistic renderings.

Embodiments allow time to be displayed in new formats that do not require either circular or numeric displays of time.

### BRIEF DESCRIPTION OF THE DRAWINGS

In the Drawings:

FIG. 1 shows a first embodiment of a linear-form clock;

FIG. 2 shows a diagram of an operational device;

FIG. 3 shows an alternative embodiment using a spiral shaped path;

FIG. 4 shows an alternative embodiment using an ellipse shaped path;

### DETAILED DESCRIPTION

The present application describes a new form clock which displays time using new forms and techniques.

According to an embodiment, a clock is described which displays time using a number of multicolor indicators, in embodiments, light-emitting elements arranged along a path. The path can be any shape of path, and can be determined by the designer's own artistic application. In an embodiment, the light emitting elements can be multicolored LEDs. The LEDs can display three colors to represent hours, minutes and seconds, respectively.

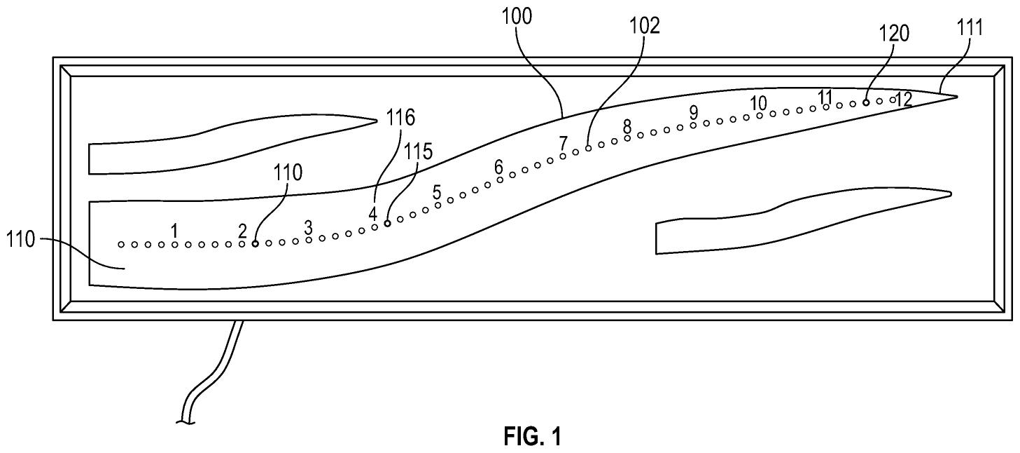

In a simple embodiment, shown in FIG. 1, there are 60 LEDs, each one of which is individually shown as 100, 102. The LEDs are arranged in a cohesive line defining a path. Starting LED 110 represents the start of the time, for example 12:00:00. Time display progresses by lighting progressive LEDs in the line in three different colors. A first color lighting represents seconds, a second color represents minutes, and a third color represents hours.

For example, in FIG. 1, the LED 115 which can be for example a orange LED, can represent the minutes. There are 60 LEDs, extending along the path, and each group of 5 LEDs includes a number which represents the hour, when associated with the hour LED. The LED 110 illuminated red, can represent the hours. As the minutes progress, the hours advance. For example, since the minutes 115 are just beyond the 4 Mark (meaning 4/12 of an hour or 20 minutes), the hours indicator 110 are one click beyond the 2 indicator. Each click between two hours (e.g., between 2 and 3) can represent ⅕ of an hour or 12 minutes.

The third LED (green) 120 represents the seconds, with the beginning of the seconds at the end 101, and the end of the seconds, at the end 111. In this way, the hours, minutes and seconds are continually advancing along the path from one end to the other at different paces.

This system in FIG. 1 represents a very simple embodiment, in which all of the LEDs are along a line, which in this case is curved, but could also be a straight line. However, the path of LEDs such as 100 can be formed along any shaped path, while retaining the ability to display time. This ability to shape the LED path into any path leads itself to ability to provide any number of artistic and unique displays. Numbers, such as 116, may be placed along the line/path to help the observer determine the time at a glance.

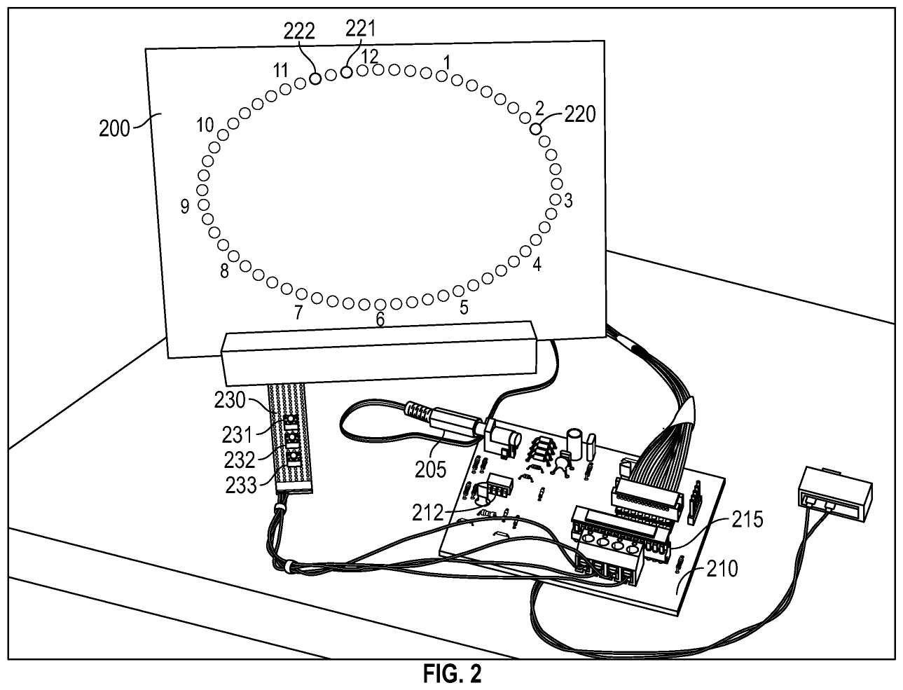

FIG. 2 illustrates the exploded parts of a second embodiment clock 200, which has the path of the serially changing lights arranged in an oval shape.

The clock 200 includes a power supply 205 which powers a circuit board 210 that includes clock processing structure 215 including for example a microprocessor 212 that is programmed to cause the lights to light and advance as described herein. The circuit board 210 drives the LEDs such as shown as 220. Each of the 60 LEDs in this embodiment are multicolor LEDs.

There are also multiple switches 230 which are used to initially set the time. A first switch 231 will advance time while depressed. Another switch 232 will reverse time while depressed. A third switch 233, which is optional, will stop time in the current position while depressed.

In an embodiment, the time is initially set by the switches 230, and then synced to the powerline frequency, which is well known to be a precise 60 Hz frequency. In other embodiments, a crystal or other stable frequency source can be used for the clock. In yet other embodiments, a time chip or programmed processor can be used to keep the time.

The circuit board also includes a processor and circuitry which determines timing and logic for the LEDs. While maintaining the time, the circuit board 210 provides an output which controls the multicolor display of time along the path.

The microprocessor determines the time of day and lights LEDs in sequence to display the current hour, minute and second in their appropriate color.

In operation, the microprocessor keeps time in an eight bit format. The time is output in the form of an eight bit by eight bit array allowing 64 points to be addressed, one at a time. 60 of those 64 points are used to display the time. Those 60 bits of the 8×8 bit array are mapped to the 60 LEDs.

Each LED will emit one color, i.e. green, when electrical current is applied across the terminals in one direction and will emit a second color; i.e. red, when the current is applied in the opposite direction.

The LEDs are selected one at a time in the correct polarity in a rapid scan that causes the human eye to perceive multiple LEDs on at the same time. A single LED may be scanned once in one polarity and again in the opposite polarity to mix the red and green colors and cause the eye to perceive a third color such as orange or yellow.

A current regulator 212 is included in the circuitry to insure each LED operates at the same current level and is therefore consistent in brightness.

The LEDs can be arranged in a linear 60 point line. Seconds are displayed by illuminating each LED in sequence at a rate of one LED per second along the line in one color such as green. Minutes are displayed by illuminating each LED in sequence along the same line at a rate of one LED per minute along the line in another color such as yellow. Hours are displayed by illuminating each LED in sequence along the same line at a rate of one LED per 12 minutes along the line in a third color such as red.

In operation, the processor determines the time of day by starting at the set time (set by a user using the switches 230) and then counting pulses from the internal clock that is synched to the power line frequency. This enables the clock to continue running on battery backup when the power mains is disconnected. The processor then sequences the different LEDs to display the current hour, minute and second, each in the appropriate color. The processor outputs the complete 8×8 array many times a second, at a rate such that the eye perceives multiples LEDs to be on at one time to allow the LED color mixing.

Minutes are displayed by illuminating each LED along the same line at the rate of one LED per minute along the line in a color such as yellow. That is, the yellow LED 220 represents the minutes, between zero and 60. In the embodiment of FIG. 2, therefore, the minutes are displaying 11 minutes.

The hours are displayed by illuminating the LEDs along the same line at a rate of one LED per 12 minutes in the red color 222. Since the minute time 220 is shown as 12 minutes, the hour LED 222 shows one point along past the hour display at 11, thus emphasizing that the time is approximately the time on the clock is 11:12:58.

In this embodiment, red is the hours, green is the seconds, and orange is the minutes, but it should be understood that different colors could be used for different time increments, and that other kinds of multicolor LEDs can be used besides those described herein.

Also, while this describes using 60 LEDs, it should be understood that other numbers of LEDs could be used, for example with 120 LEDs to show half seconds, or 30 LEDs to show a second hand which changes only every 2 seconds.

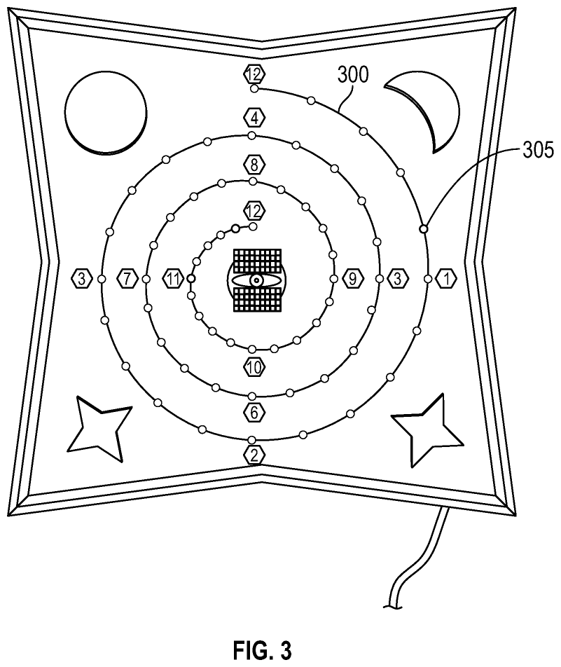

FIG. 3 illustrates an alternative embodiment, in which the path 300 is along a spiral, and the time is illuminated by selecting different LEDs such as 305 along the spiral path.

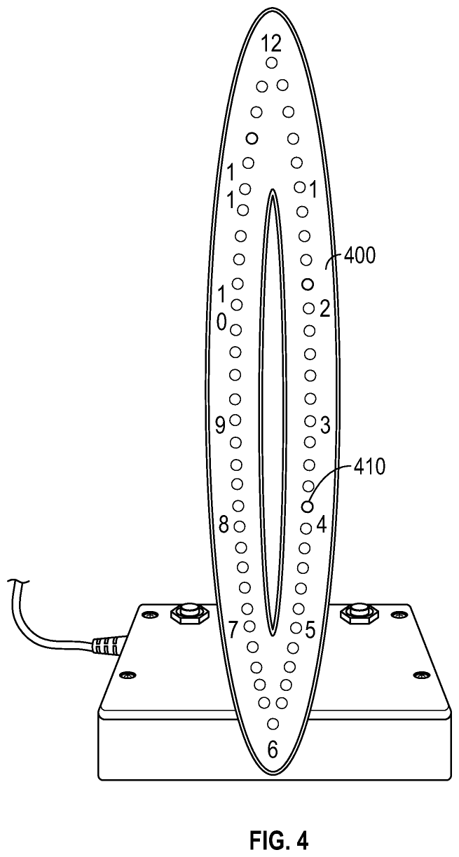

FIG. 4 shows an alternative embodiment, in which the path is along an ellipse like shape 400, and different LEDs such as 410 are illuminated along that ellipse like shape.

Any path, however, can be used in accordance with the teachings of this invention.

Although this invention uses dedicated hardware, it could be simulated by a general computer. It could also utilize different kinds of light emitting display elements in place of the LEDs. Another embodiment uses a dedicated integrated circuit for keeping times in clocks, which produces an output indicative of the time, and that output is then mapped to the 8×8 array, which is output to the LEDs.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A clock comprising:
a series of lighting elements arranged along a path;
a driver for the lighting elements; and
a computing device which keeps track of a current time, the computing device operating the driver for the lighting elements to change the lighting elements which are illuminated along the path based on the time,
where the computing device operates the driver to light a first element at a first location along the path representing minutes of the current time, and to light a second element at a second location along the path based on hours of the current time.

2. The clock as in claim 1, wherein the lighting elements are along a single continuous path.

3. The clock as in claim 2, wherein each of the lighting elements are energized to display in multiple colors, with a first color representing hours, and a second color representing minutes.

4. The clock as in claim 3, further comprising each of the lighting elements being displaying in a third color representing seconds, and where there are 60 of the lighting elements.

5. The clock as in claim 4, wherein the display of the third color representing seconds changes once a second, the display of the second color representing minutes changes once a minute, and the display of the first color representing hours changes once every 12 minutes.

6. The clock as in claim 3, where the computing device includes switches which control setting a current time, and a timekeeping device which monitors elapsed time, and changes which of the lighting devices are illuminated, in respective colors, based on starting at the current time and continuing to the present time.

6. The clock as in claim 4, wherein the computing device creates an array which includes 60 different values, each value representing a value for display of one of the lighting elements, to represent the current time.

7. The clock as in claim 4, wherein the lighting elements are multicolor LEDs.

8. The clock as in claim 7, further comprising a current limiting device which enforces each of the multicolor LEDs having a similar brightness.

9. The clock as in claim 1, wherein the path is a curved line.

10. The clock as in claim 1, wherein the path is an oval.

11. The clock as in claim 1, wherein the path is a spiral.

12. A method of displaying time, comprising:
creating a display surface which includes 60 different display elements; arranged along a path;
lighting a first of the display elements in a first color to represent a current hour setting of the time;
lighting a second of the display elements in a second color to represent a current minute setting of the time;
and
lighting a third of the display elements in a third color to represent a current second setting of the time.

13. The method as in claim 12, wherein further comprising updating the lighting of the third of the display elements each second, updating the lighting of the second of the display elements each minute, and updating the lighting of the first of the display elements each 12 minutes.

14. The method as in claim 13, wherein the updating comprises creating an 8×8 array for the 60 different display elements, mapping one element of the array to each of the 60 display elements, and updating the array each second to change at least a one display element which is lit each second.

15. The method as in claim 12, wherein the path is a curved line.

16. The method as in claim 12, wherein the path is an oval.

17. The method as in claim 12, wherein the path is a spiral.
